(19) United States
(12) Patent Application Publication
(10) Pub. No.: US 2013/0009533 A1
(43) Pub. Date: Jan. 10, 2013

(54) High-pressure discharge lamp with graduated outer bulb

(75) Inventors: Jürgen Kellerer, Berlin (DE); Sascha Piltz, Berlin (DE); Karen Twesten, Berlin (DE); Jan Ullrich, Berlin (DE)

(73) Assignee: OSRAM AG, Muenchen (DE)

(21) Appl. No.: 13/580,969

(22) PCT Filed: Feb. 4, 2011
(86) PCT No.: PCT/EP11/51664

§ 371 Date: Sep. 19, 2012

(30) Foreign Application Priority Data
Feb. 26, 2010 (DE) 102010002397.3

(51) Int. Cl. H01J 61/30; H01J 5/16; H01J 61/36

(52) U.S. Cl. 313/113; 313/634; 313/623

(57) ABSTRACT

The high-pressure discharge lamp comprises an outer bulb having two tubular sections which are axially aligned, wherein a first section is arranged at the first end of the outer bulb and comprises a cylindrical zone having an outside diameter (d1), and wherein a second section having a diameter (d2) which is smaller than (d1) is attached thereto.

### TECHNICAL FIELD

The invention is based on a high-pressure discharge lamp according to the preamble of claim 1. Lamps of said type are in particular high-pressure discharge lamps having a ceramic discharge vessel and metal halide fill.

### BACKGROUND ART

DE 102007015483 and WO 2006/081804 each disclose a reflector lamp which employs a built-in lamp, based on a ceramic discharge vessel having a metal halide fill. These lamps are anchored additionally in the reflector by means of aids, for example through the use of potting compounds, e.g. silicone resins or base mastic. An alternative is to use double-ended lamps.

In this case the outer bulb is either left constant in diameter in the course of the adjustment or more likely narrowed; see DE19913297.

### SUMMARY OF THE INVENTION

An object of the present invention is to provide a high-pressure discharge lamp which can easily be mounted in a reflector and which has a particularly high electrical breakdown strength.

This object is achieved by means of the characterizing features of claim 1.

Particularly advantageous embodiments can be found in the dependent claims.

The problem is solved by means of an outer bulb envelope construction which consists of two bulb sections of different size. In this case the upper outer bulb tube section (=the dome-side section or the section which is located in the direction of the reflector output of the lamp unit) has a smaller diameter d2 than the lower outer bulb tube section—in other words, the base-side section or the section which is located in the direction of the reflector neck of the lamp unit—with diameter d1. Preferably the relation 0.55≦d2/d1≦0.85 applies.

The diameter d2 of the upper outer bulb tube section has an optimization criterion which is different from the optimization criterion of the lower outer bulb tube section. The diameter d2 should be as small as possible in relation to d3, where d3 represents the diameter of the discharge vessel. Preferably the relation (d2−d3)/2≦3 applies. The effect of this optimization approach is that the enveloping reflector curve of a lamp can be brought very close to the discharge vessel, thereby increasing the efficiency of the reflector of the lamp unit. More useful light is reflected into the desired illumination footprint and less lost light is emitted into the reflector neck of the lamp unit.

In contrast, a totally different optimization approach applies in the case of the lower outer bulb tube section, namely increasing the electrical breakdown strength. The aim here is to achieve the widest possible distance a between the outermost current lead-in wires. In the case of a starting voltage of 10 kV, for example, a distance a >14 mm is required. To achieve this, d1 must be maximized as much as possible in relation to d3 and/or d2. While ratios of d3/d1>0.4 are standard for commonly available, single-part outer bulb tubes, in particular a ratio of d3/d1≦0.4 can now be achieved.

The length h2 of the lower, flared outer bulb tube section is preferably shorter than the distance from the center of the discharge vessel to the lower outer bulb tube edge h1. The smallest possible length h2 applies as optimization criterion. Advantageously, the ratio of h2/h1 should amount to ≦0.6.

The sealing technology for the evacuated outer bulb can be selected as is usual in the case of conventional high-pressure discharge lamps, in particular pinching in the lower region, drawing and fusing of the exhaust tube in the upper region. The outer bulb consists in particular of hard glass, though fused quartz glass is preferred. To provide effective UV protection, the quartz glass can be doped with additives, e.g. cerium, as known per se.

The bottleneck shape can be produced in a variety of ways, the following exemplary embodiments in particular being advantageous:

An outer bulb output tube, consisting of a tube section with diameter d2 and a fused-on exhaust tube on the dome side, is heated and widened by means of a forming tool at the lower tube section to the diameter d1 corresponding to the length h2. The mounting frame with the arc tube is then introduced into the outer bulb and pinched in place in the lower, flared section of the outer bulb under the application of heat.

Two outer bulb tubes with the diameters d1 and d2 are joined together in a similar manner to the exhaust tube attachment process. Toward that end, both tubes are set into rotation, heated at the two ends that are to be fused and joined to each other by means of axial movement. In order to ensure that a gas-tight bond can be produced, the larger of the two tube sections should be preformed such that a shoulder is created whose opening diameter corresponds to the diameter d2 of the smaller tube section. The rest of the fabrication process corresponds to that of point 1).

The mounting frame is threaded as far as possible into an outer bulb starting tube, consisting of a tube section with diameter d2 and a fused-on exhaust tube on the dome side. Heat is then applied, thereby softening the lower part of the outer bulb starting tube over the length h2, and in a first forming process the lower section is fashioned into an oval shape by means of two pinching jaws. Once this section is wide enough, the rest of the mounting frame is introduced and then the second pinching process is carried out, leading to the sealing of the base-side outer bulb tube. This type of bulb shaping will have a pinch which has no pinching land at the side. The base shape is therefore not double-T-shaped in profile (FIG. 6), but flat (FIG. 7).

The lamp preferably employs a ceramic discharge vessel which is accommodated in an outer bulb envelope. In principle, however, the inner vessel can also be a different type of high-pressure discharge lamp.

Advantages of the new design are in particular:

The lower, flared outer bulb tube section permits the use of current lead-in wires which are arranged at such a great distance from each other that electrical breakdowns in atmospheric air at high starting voltages, e.g. at ≧10 kV, cannot take place. This means that hot-restrike-capable and instant-start-capable high-pressure discharge lamps can be operated.

The upper, narrowed outer bulb tube section permits the use of the lamp in reflectors which have only a very small reflector neck opening. The purpose of this is to gain as much useful light as possible, and to lose little light in the direction of the reflector neck.

Less scattered light in the reflector neck also means a smaller risk of retroreflection onto the lower fused seal of the capillary tubes, thereby reducing the risk of thermally induced damage and consequently premature failure.

The volume of the outer bulb can be very small, provided d2 and h2 are very small. As a result the lamp will reach a thermally stable operating state more quickly after being switched on.

The availability of an outer bulb shape of said type permits existing production processes and machinery to be retained. Only the forming process to shape the starting tube would need to be modified.

### BRIEF DESCRIPTION OF THE DRAWINGS

The invention will be explained in more detail below with reference to several exemplary embodiments. In the figures:

FIG. 1 shows a lamp having a ceramic discharge vessel in an outer bulb;

FIG. 2 shows a view from below onto the lamp from FIG. 1;

FIG. 3 shows a reflector lamp having a lamp of said type;

FIG. 4 shows a blank for the outer bulb;

FIG. 5 shows a further exemplary embodiment of a blank;

FIG. 6 shows a further exemplary embodiment of a lamp;

FIG. 7 shows a view from below onto the lamp from FIG. 6.

### PREFERRED EMBODIMENT OF THE INVENTION

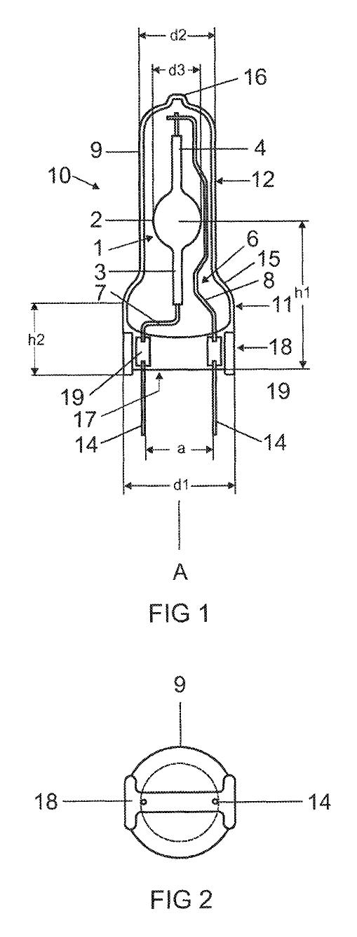

FIG. 1 shows a metal halide lamp 10. The latter is, for example, a 150 W lamp having a ceramic discharge vessel 1. It is used in particular as a built-in lamp.

The discharge vessel 1 is made up of a bulbous central part 2 and two end sections 3, 4. Each end section 3, 4 is sealed by means of a capillary technique, as known per se.

The discharge vessel made of ceramic is housed in an outer bulb 9 made of glass, generally hard glass or quartz glass, by means of a mounting frame 6 having a short and long current lead-in 7, 8. The outer bulb is divided into two parts. A first section 11 is cylindrical with an outer diameter d1, and on it is seated a second section 12 which is likewise cylindrical, but has a reduced outer diameter d2. The axial length of the second section is advantageously dimensioned such that the central part 2 of the discharge vessel is accommodated entirely in the second section 12. The maximum outer diameter of the discharge vessel is designated by d3. In this case the fundamental relationship d3<d2<d1 applies. In particular, there is a difference of at least 10% between each of the three diameters. The height of the light center, in other words the center of the discharge arc, is designated by h1, which is important for the positioning in a reflector. Moreover, the length of the lower section of the outer bulb is designated by h2. Disposed between first and second section of the outer bulb is a transition zone 15 in which the diameter reduces from d1 to d2.

The outer bulb is provided with an exhaust pip 16 at its upper end. The outer bulb is evacuated.

The outer bulb is sealed at its lower end 17. For this, either a pinch 18 with two foils 19 is used (as shown) or else a fused seal. The current lead-ins 7, 8 of the mounting frame each end at said foils 19. From there, two feed lines 14 are brought to the outside. The distance between the two feed lines 14 can be chosen so as to very great here; it is designated by a.

FIG. 2 shows a plan view from below onto the lamp of FIG. 1.

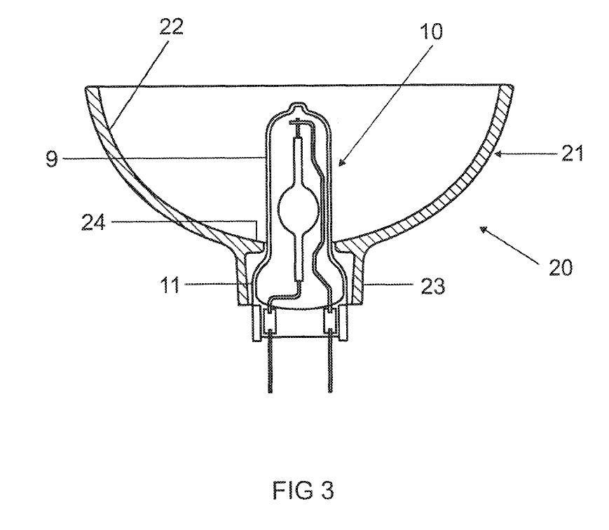

FIG. 3 shows a reflector lamp 20. The latter employs the above-described lamp 10 as a built-in lamp, wherein a reflector 21 is equipped with a contour 22 and a neck 23. The neck is seated on the lamp 10 in the region of the second section. In this case the contour 22 is extended (24) in particular in the direction of the outer bulb 9 such that it fits tightly against it, with the result that the light quantity is optimally collected by means of the contour.

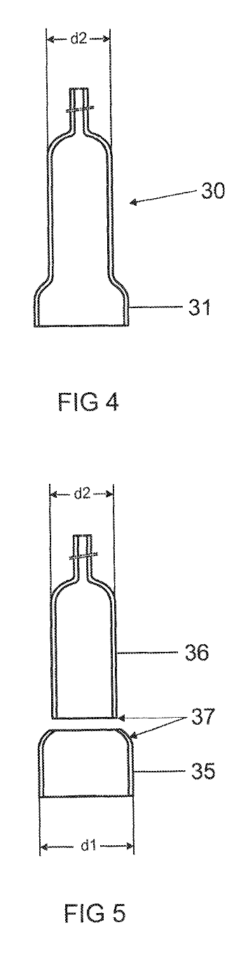

The fabrication of the novel outer bulb is accomplished in various ways. One possibility is illustrated in FIG. 4. Here, an original blank 30 with constant diameter d2 is heated at its lower end 31 and then flared.

An alternative is shown in FIG. 5. In this case a first blank 35 with diameter d1 and a second blank 36 with diameter d2 are used, the two being fused together after heating of the adjacent border zones 37.

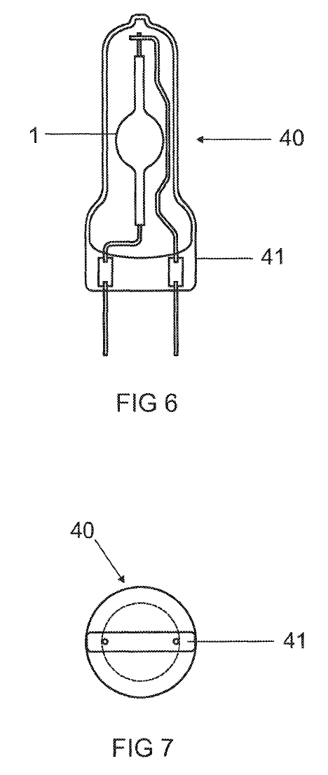

FIG. 6 shows another exemplary embodiment of a lamp 40, wherein side lands in the region of the pinch 41 are dispensed with. FIG. 7 shows a view from below onto the lamp 40.

Suitable candidates as filling for the discharge vessel 1 are known metal halide systems such as rare earth metal halides, Na iodide, Ca iodide, thallium iodide, etc., with or else without Hg, as well as inert gas. A fill containing CeJ3 is well-suited. Suitable inert gases are in particular Xe or Ar; the cold fill pressure lies approximately in the 2 to 5 bar range.

Significant features of the invention, itemized in the form of a numbered list, are:
1. High-pressure discharge lamp having a discharge vessel which is accommodated in an outer bulb, wherein a longitudinal axis is defined such that the discharge vessel is orientated along the axis, wherein the outer bulb possesses two ends and is sealed at least at a first end, characterized in that the outer bulb has two tubular sections which are aligned axially, wherein a first section is arranged at the first end and has a cylindrical zone with an outer diameter d1, and wherein a second section is attached thereto and has a diameter d2 which is less than d1.
2. High-pressure discharge lamp as claimed in claim 1, characterized in that the discharge vessel is fabricated from ceramic and has a central part and two ends.
3. High-pressure discharge lamp as claimed in claim 1, characterized in that d2 lies in the range 0.55≦d2/d1≦0.85.
4. High-pressure discharge lamp as claimed in claim 1, characterized in that the first section has a sealing zone which is not cylindrical.
5. High-pressure discharge lamp as claimed in claim 1, characterized in that seated in the sealing zone are feed lines spaced apart by a distance a that is chosen such that a hot restrike is possible.
6. High-pressure discharge lamp as claimed in claim 1, characterized in that the distance a is chosen so as to be greater than d2.
7. High-pressure discharge lamp as claimed in claim 1, characterized in that the outer bulb is fabricated from quartz glass, wherein foils are connected to the feed lines in the sealing zone.
8. High-pressure discharge lamp as claimed in claim 1, characterized in that the discharge vessel is retained in the outer bulb by means of a mounting frame.
9. High-pressure discharge lamp as claimed in claim 1, characterized in that the lamp is surrounded by a reflector which possesses a contour and a neck, wherein the neck is connected to the outer bulb in the region of the first section.
10. High-pressure discharge lamp as claimed in claim 1, characterized in that the contour is extended beyond the neck in the direction of the outer bulb.
11. High-pressure discharge lamp as claimed in claim 1, characterized in that the outer bulb is made up of two tube blanks having a different diameter.
12. High-pressure discharge lamp as claimed in claim 1, characterized in that a transition zone connects the two sections to each other.

1. A high-pressure discharge lamp having a discharge vessel which is accommodated in an outer bulb, wherein a longitudinal axis is defined such that the discharge vessel is orientated along the axis, wherein the outer bulb possesses two ends and is sealed at least at a first end, characterized in that the outer bulb has two tubular sections which are aligned axially, wherein a first section is arranged at the first end and has a cylindrical zone with an outer diameter d1, and wherein a second section is attached thereto and has a diameter d2 which is less than d1.

2. The high-pressure discharge lamp as claimed in claim 1, characterized in that the discharge vessel is fabricated from ceramic and has a central part and two ends.

3. The high-pressure discharge lamp as claimed in claim 1, characterized in that d2 lies in the range 0.55≦d2/d1≦0.85.

4. The high-pressure discharge lamp as claimed in claim 1, characterized in that the maximum diameter of the discharge vessel d3 is chosen such that (d2−d3)/2≦3 applies.

5. The high-pressure discharge lamp as claimed in claim 1, characterized in that the first section has a sealing zone which is not cylindrical.

6. The high-pressure discharge lamp as claimed in claim 1, characterized in that seated in the sealing zone are feed lines spaced apart by a distance a that is chosen such that a hot restrike is possible.

7. The high-pressure discharge lamp as claimed in claim 1, characterized in that the distance a is chosen so as to be greater than d2.

8. The high-pressure discharge lamp as claimed in claim 1, characterized in that the outer bulb is fabricated from quartz glass, wherein foils are connected to the feed lines in the sealing zone.

9. The high-pressure discharge lamp as claimed in claim 1, characterized in that the discharge vessel is retained in the outer bulb by means of a mounting frame.

10. The high-pressure discharge lamp as claimed in claim 1, characterized in that the lamp is surrounded by a reflector which possesses a contour and a neck, wherein the neck is connected to the outer bulb in the region of the first section.

11. The high-pressure discharge lamp as claimed in claim 1, characterized in that the contour is extended beyond the neck in the direction of the outer bulb.

12. The high-pressure discharge lamp as claimed in claim 1, characterized in that the outer bulb is made up of two tube blanks having a different diameter.

13. The high-pressure discharge lamp as claimed in claim 1, characterized in that a transition zone connects the two sections to each other.
